(19) United States
(12) Patent Application Publication
(10) Pub. No.: US 2008/0306647 A1
(43) Pub. Date: Dec. 11, 2008

(54) IN-VEHICLE NETWORK SYSTEM AND CONTROL METHOD THEREOF

(76) Inventors: JAE WOOK JEON, Suwon-si (KR); Suk Hyun Seo, Suwon-si (KR); Tae Yoon Moon, Suwon-si (KR); Jin Ho Kim, Suwon-si (KR)

Correspondence Address: PARK LAW FIRM, 3255 WILSHIRE BLVD, SUITE 1110, LOS ANGELES, CA, 90010, US

(21) Appl. No.: 12/022,962

(22) Filed: Jan. 30, 2008

(30) Foreign Application Priority Data
Jun. 11, 2007 (KR) 10-2007-0056693

(51) Int. Cl. G06F 19/00

(52) U.S. Cl. 701/29; 701/1

(57) ABSTRACT

The present invention relates to an in-vehicle networks system and a method of controlling the same. The in-vehicle network system includes a first actuator and second actuators; shared sensors outputting a sensing value according to a sensing result; a first sub ECU controlling the driving of the first actuator and outputting a first sub sensing value corresponding to the sensing value from the shared sensors; a second sub ECU controlling the driving of the first actuator and outputting a second sub sensing value corresponding to the sensing value from the shared sensors; and a main ECU communicating with the first sub ECU and the second sub ECU according to a TDMA-based communication protocol, and determining that any one of the first ECU and the second ECU is abnormal in case that a difference between the first sensing value and the second sensing value is out of an error tolerance.

### BACKGROUND OF THE INVENTION

1. Field of the Invention

The present invention relates to an in-vehicle network system and a control method thereof; more particularly, to a network system and a control method thereof capable of improving a resistance to an error by allowing each of sub-electronic control units connected through a network to perform complementary roles.

2. Background of the Related Art

As public vehicles such as automobiles and buses, or military vehicles (hereinafter, referred to as ‘vehicle’) become to develop in function and quality, the development of intelligent vehicle technologies has been increased.

Generally, in order to realize an intelligent vehicle, state information such as a position or a speed of the vehicle and environmental information for the outside of the vehicle should be recognized and detected in real time, and the vehicle should be controlled semiautomatically or automatically so as to prevent an accident.

For this reason, the intelligent vehicles requires intelligent sensing and control algorithms such as a driver assistance system for controlling a part of the vehicle for driver's convenience or a collision warning system for providing information to a driver and warning an endangerment and the like. In particular, as the intelligent vehicle has been evolved to a high level, the number of additional electronic components such as an acceleration sensor, a temperature sensor, a radar sensor, various control motors and the like of the vehicle also has been rapidly increased.

A vehicle wiring system (Harness system) in which an electronic component such as a senor or an actuator, an ECU (Electronic Control Unit) or a switch is one-to-one connected to each other by the use of cables was applied to an initial intelligent vehicle. An increment in the number of electronic components or switches led to an increment in the number of cables, thereby inducing the complexity of a wiring system, making maintenance of the vehicle or addition of new functions difficult and increasing the weight of the vehicle to lower a driving performance by increasing the weight thereof.

In order to solve these problems, an in-vehicle network system in which the electronic components, the ECU and the switch are connected to each other by the use of one shared cables had been proposed and studied. As a result, a LIN (Local Interconnect Network) protocol and a CAN (Controller Area Network) protocol which are network protocols for vehicle control had been developed. Further, a FlexRay protocol has been recently developed.

Herein, the FlexRay protocol has been developed to reflect a practical problem that an information amount flowing on the network rapidly increases while the number of the electronic control units connected to an in-vehicle network increases as various components including an engine or a brake are controlled so as to improve the stability or the fuel efficiency of the vehicle. The FlexRay protocol can transmit and receive data at a transmission speed (10 megabits/sec.) 10 times higher than the CAN protocol and the FlexRay protocol has a reliability at the time of transmitting the data higher than that of the CAN protocol.

The FlexRay protocol, as a TDMA (Time Division Multiple Access)-based communication protocol, has a constant communication cycle and several time slots exist within the communication cycle. The time slots are set to transmit or receive a message, that is, the data.

Herein, while one node is set to send the data for one time slot, one or more other nodes are set to receive the data for the same time slot. That is, the FlexRay protocol provides the same time slot after synchronizing with all nodes connected to the network.

For example, in case that 10 time slots exist for one cycle, a first node is set to send the data and a second node is set to receive the data for a first time slot. The first and second nodes perform the same operation after the cycle.

Since the data can be sent at an accurate time through such operation, an operation and a phenomenon of the network system can be previously predicted, the FlexRay protocol has been recognized as a high-reliability communication protocol.

As the possibility and utilization of an electronic control using the above-mentioned in-vehicle communication protocol are increased, various kinds of sensors for the drive or the safety of the vehicle, or other driver's convenience are connected to the electronic control units and actuators via the communication protocol.

The sensing results of the sensors provide important information for the electronic control unit to control the drive of the actuators and various researches for minimizing errors of the sensors have been continuously progressed. In case that an error caused due to misrecognition of the sensing results by the electronic control unit receiving the sensing result from the corresponding sensor can be also corrected in addition to a sensor's own failure or error, an in-vehicle network system resistant to the error will be able to be preferably realized.

### SUMMARY OF THE INVENTION

### Technical Problem

It is, therefore, an object of the present invention to provide a network system and a control method thereof capable of improving a resistance to an error by allowing each of sub-electronic control units connected through a network to perform complementary roles.

### Technical Solution

In order to achieve the above-mentioned object of the present invention, an in-vehicle network system in accordance with an aspect of the present invention includes a first actuator and at least one second actuator; at least one shared sensor outputting a sensing value according to a sensing result; a first sub ECU (Electronic Control Unit) controlling the driving of the first actuator and outputting a first sub sensing value corresponding to the sensing value received from the shared sensor; a second sub ECU controlling the driving of the first actuator and outputting a second sub sensing value corresponding to the sensing value received from the shared sensor; and a main ECU communicating with the first sub ECU and the second sub ECU according to a TDMA (Time Division Multiple Access)-based communication protocol, and determining that any one of the first ECU and the second ECU is abnormal in case that a difference between the first sensing value and the second sensing value respectively outputted from the first sub ECU and the second sub ECU is out of an error tolerance.

Herein, the TDMA-based communication protocol may include a FlexRay protocol.

The main ECU may transmit a middle value between the first sub sensing value and the second sub sensing value to at least any one of the first sub ECU and the second sub ECU in case that the difference between the first sub sensing value and the second sub sensing value is out of the error tolerance, and the first sub ECU and the second sub ECU may control the driving of the first actuator and the driving of the second actuator on the basis of the middle value transmitted from the main ECU.

The main ECU may control the driving of at least any one of the first actuator and the second actuator by taking over a control right to the driving of at least any one of the first actuator and the second actuator of at least any one of the first sub ECU and the second sub ECU in case that the difference between the first sub sensing value and the second sub sensing value is out of the error tolerance.

The main ECU may request the first sub ECU and the second sub ECU to retransmit the first sub sensing value and the second sub sensing value in case that the difference between the first sensing value and the second sensing value is out of the error tolerance, and the first sub ECU and the second sub ECU may receive the sensing values from the shared sensor again to regenerate the first sub sensing value and the second sub sensing value, and reoutput the first sub sensing value and the second sub sensing value to the main ECU.

The main ECU may inform at least any one of the first sub ECU and the second sub ECU of information on a normal state in case that the difference between the first sub sensing value and the second sub sensing value is within the , and the first sub ECU and the second sub ECU may control the driving of the first actuator and the driving of the second actuator on the basis of the sensing value of the shared sensor in case that the information on the normal state is received from the first main ECU.

Herein, the sensing value outputted from the shared sensor may include an analog signal pattern, and the first sub sensing value and the second sub sensing value may include a digital signal pattern, the first sub ECU may include a first A/D converter for converting the sensing value of the analog signal pattern into the first sub sensing value of the digital signal pattern, and the second sub ECU may include a second A/D converter for converting the sensing value of the analog signal pattern into the second sub sensing value of the digital signal pattern.

Meanwhile, in order to achieve the above-mentioned object, a method of controlling the network system in accordance with another aspect of the present invention further includes the steps of: outputting a sensing value according to a sensing result from a shared sensor; outputting a first sub sensing value corresponding to the sensing value by a first sub ECU controlling the driving of a first actuator; outputting a second sub sensing value corresponding to the sensing value by a second sub ECU controlling the driving of a second actuator; inputting the first sensing value and the second sensing value to a main ECU communicating with the first sub ECU and the second sub ECU according to a TDMA-based communication protocol; and determining that any one of the first sub ECU and the second sub ECU is abnormal by the main ECU in case that a difference between the first sub sensing value and the second sub sensing value is out of a previously set error tolerance.

Herein, a TDMA-based communication protocol may include a FlexRay protocol.

The method of controlling the network system may further include the steps of transmitting a middle value between the first sub sensing value and the second sub sensing value to at least any one of the first sub ECU and the second sub ECU by the main ECU in case that the difference between the first sub sensing value and the second sub sensing value is out of the error tolerance; and controlling the driving the first actuator and the driving of the second actuator on the basis of the middle value transmitted from the main ECU by the first sub ECU and the second sub ECU.

The method of controlling the network system may further include the step of: controlling the driving of at least any one of the first actuator and the second actuator by the main ECU by taking over a control right of the driving of at least any one of the first actuator and the second actuator from at least any one of the first sub ECU and the second sub ECU to the main ECU in case that the difference between the first sub sensing value and the second sub sensing value is out of the error tolerance.

The method of controlling the network system may further include the steps of: requesting the first sub ECU and the second sub ECU to retransmit the first sub sensing value and the second sub sensing value by the main ECU in case that the difference between the first sensing value and the second sensing value is determined out of the error tolerance by the main ECU; respectively receiving the sensing values from the shared sensor again by the first sub ECU and the second sub ECU to regenerate the first sub sensing value and the second sub sensing value; and reoutputting the regenerated first sub sensing value and the regenerated second sub sensing value to the main ECU by the first sub ECU and the second sub ECU.

Herein, the method of controlling the network system may further include the steps of: informing at least any one of the first sub ECU and the second sub ECU of information on a normal state by the main ECU in case that the difference between the first sub sensing value and the second sub sensing value is determined within the error tolerance by the main ECU; and controlling the driving of the first actuator and the second actuator on the basis of the sensing value of the shared sensor by the first sub ECU and the second sub ECU in case that the first sub ECU and second sub ECU receive information on the normal state from the main ECU.

The sensing value outputted from the shared sensor may include an analog signal pattern, and the first sub sensing value and the second sub sensing value may include a digital signal pattern, the step of outputting the first sub sensing value may include a step of converting the sensing value of the analog signal pattern into the first sub sensing value of the digital signal pattern, and the step of outputting the second sensing value may include a step of converting the sensing value of the analog signal pattern into the second sub sensing value of the digital signal pattern.

### Effect of the Invention

As described above, in accordance with the present invention, there is provided a network system and a control method thereof capable of improving a resistance to an error by allowing each of sub-electronic control units connected through a network to perform complementary roles.

### BRIEF DESCRIPTION OF THE DRAWINGS

FIG. 1 is a diagram showing a configuration of a network system in accordance with the present invention;

FIG. 2 is a diagram illustrating an operation process of a main electronic control unit of the network system in accordance with the present invention; and

FIG. 3 is a diagram illustrating operation processes of a first sub electronic control unit and a second sub electronic control unit of the network system in accordance with the present invention.

### DETAILED DESCRIPTION OF THE INVENTION

Hereinafter, preferred embodiments of the present invention will be described in more detail with reference to the accompanying drawings.

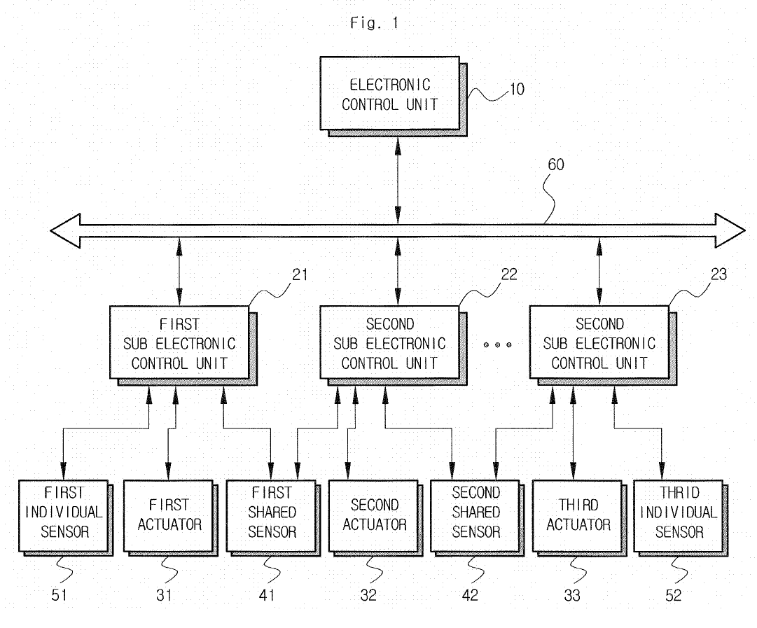

As shown in FIG. 1, an in-vehicle network system in accordance with the present invention includes a first actuator 31, a second actuator 32, a first shared sensor 41, a first sub electronic control unit (hereinafter, referred to as an “ECU”) 21, at least one second sub ECU 22 and a main ECU 10.

The first actuator 31 and the second actuator 32 are driven according to the control of the first sub ECU 21 and the control of the second sub ECU 22, respectively. Herein, the first actuator 31 and the second actuator 32 may be used for a driving operation related to an actual operation of a vehicle such as driving or a brake, or for a driving operation of components for a user's driving convenience.

The first shared sensor 41 outputs a sensing value generated from a first shared sensor's own sensing result. For example, in case that the first shared sensor 41 is a sensor sensing the acceleration of the vehicle, the sensing value outputted from the first shared sensor 41 reflects the acceleration of a driving vehicle.

Herein, a sensor having the highest importance among in-vehicle sensors, for example, a sensor related to a safety of the vehicle such as the driving or the brake can be assigned as the first shared sensor 41.

The sensing value outputted from the first shared sensor 41 is inputted into the first actuator 31 and the second actuator 32. Herein, the sensing value outputted from the first shared sensor 41 having an analog signal pattern is described as one example.

The first sub ECU 21 controls the driving of the first actuator 31. The first sub ECU 21 outputs a first sub sensing value corresponding to the sensing value received from the first shared sensor 41. Herein, the first sub sensing value may be generated in a digital signal pattern. Accordingly, the first sub ECU 21 may includes a first A/D converter for converting the sensing value of the analog signal pattern into the first sub sensing value of the digital signal pattern.

The second sub ECU 22 controls the driving the second actuator 32. The second sub ECU 22 outputs a second sub sensing value corresponding to the sensing value received from the first shared sensor 41. Herein, the second sub sensing value may be generated in the digital signal pattern similarly as the first sub sensing value. Accordingly, the second sub ECU 22 may include a second A/D converter for converting the sensing value of the analog signal pattern into the second sub sensing value of the digital signal pattern.

At least any one of the first sub ECU 21 and the second sub ECU 22 can control of the driving the first actuator 31 and/or the second actuator 32 on the basis of the sensing value sensed by the first share sensor 41. This includes a case that both the first sub ECU 21 and the second sub ECU 22 control the driving of the first actuator 31 and the driving of the second actuator 32 on the basis of the sensing value sensed by the first shared sensor 41, a case that the only first sub ECU 21 (or the only second sub ECU 22) control the driving of the first actuator 31 (or the second actuator 32) on the basis of the sensing value sensed by the first shared sensor 41, and a case that the second sub ECU 22 (or the first subs ECU 21) reflects the importance of the first shared sensor 41 and receives the sensing value of the first shared sensor 41 so as to detect an error of the first sub ECU 21 (or the second sub ECU 22) through the comparison by the main ECU 10 to be described later. Hereinafter, an embodiment that both the first sub ECU 21 and the second sub ECU 22 control the driving of the first actuator 31 and the driving of the second actuator 32 on the basis of the sensing value from the first shared sensor 41 is described as an example.

The main ECU 10 communicates with the first sub ECU 21 and the second sub ECU 22 according to a TDMA (Time Division Multiple Access)-based communication protocol. The first shared sensor 41 communicates with the first sub ECU 21 and the second sub ECU 22 according the TDMA-based communication protocol. Herein, an embodiment that a FlexRay protocol is used as the TDMA-based communication protocol in accordance with the present invention is described as one example. In case that the main ECU 10, the first sub ECU 21, the second sub ECU 22, and the first shared sensor 41 can be synchronized according to the TDMA, another communication protocol may be also used as the TDMA-based communication protocol.

The main ECU 10 calculates a difference between the first sub sensing value and the second sub sensing value outputted from the first sub ECU 21 and the second sub ECU 22, respectively. The main ECU 10 determines whether or not the first sub ECU 21 and/or the second sub ECU 22 are/is abnormal according to whether or not the calculated difference is out of a previously set error tolerance. That is, the main ECU 10 determines that at least any one of the first sub ECU 21 and the second sub ECU 22 is abnormal in case that the calculated difference is out of the previously set error tolerance.

Herein, the difference between the first sub sensing value and the second sub sensing value may be generated in various reasons such as a difference which may be generated at the time when the first sub ECU 21 and the second sub ECU 22 convert the sensing value from the shared sensor 41 into the sensing value of the digital signal pattern or a difference which may be generated in the course of the transmission of the first sub sensing value and the second sub sensing value and so forth.

Meanwhile, the main ECU 10 may transmit a middle value between the first sub sensing value and the second sub sensing value to the first sub ECU 21 and the second sub ECU 22 in case that the difference between the first sub sensing value and the second sub sensing value is out of the error tolerance.

At this time, the first sub ECU 21 and the second sub ECU 22 which receive the middle value from the main ECU 10 may control the driving of the first actuator 31 and the driving of the second actuator 32 on the basis of the received value rather than the sensing value from the shared sensor 41.

The operations of the first sub ECU 21 and the second sub ECU 22 may be applied in case that the difference between the first sub sensing value and the second sub sensing value approaches the error tolerance, that is, the difference between the first sub sensing value and the second sub sensing value is not large.

The main ECU 10 may directly control the driving of the first actuator 31 and the driving of the second actuator 32 by taking over the control rights of the driving of the first actuator 31 and the driving of the second actuator 32 from the first sub ECU 21 and the second sub ECU 22 in case that the difference between the first sub sensing value and the second sub sensing value is out of the error tolerance.

The main ECU 10 may directly control the driving of the first actuator 31 and the driving of the second actuator 32 in case that the difference between the first sub sensing value and the second sub sensing value is out of the error tolerance, for example, the first sub sensing value and the second sub sensing value are out of a reliable range. Herein, the direct control by the main ECU 10 may be performed on the basis of a default value previously set on the main ECU 10 for the first shared sensor 41.

The main ECU 10 may request the first sub ECU 21 and the second sub ECU 22 to retransmit the first sub sensing value and the second sub sensing value in case that the difference between the first sub sensing value and the second sub sensing value is out of the error tolerance.

At this time, the first sub ECU 21 and the second sub ECU 22 receives the sensing values from the first shared sensor 41 again to regenerate the first sub sensing value and the second sub sensing value. The first sub ECU 21 and the second sub ECU 22 output the regenerated first sub sensing value and the second sub sensing value to the main ECU 10.

Herein, the main ECU 10 compares the first sub sensing value and the second sub sensing value reoutputted from the first sub ECU 21 and the second sub ECU 22 to determine whether or not the difference between the first sub sensing value and the second sub sensing value is out of the error tolerance. At this time, the main ECU 10 may perform any one of the above-mentioned other two control processes in case that the difference is out of the error tolerance.

Referring back to FIG. 1, the network system in accordance with the present invention may further include a third sub ECU 23 for controlling the driving of a third actuator 33 and the third sub ECU 23 receives sensing values from the second subs ECU 22 and a second shared sensor 42. As described above, in the network system in accordance with the present invention, the plural shared sensors 41 and 42 are prepared and the plural sub ECUs 21, 22 and 23 generate the sub sensing values according to the sensing values from the shared sensors 41 and 42 to transmit the generated sub sensing values to the main ECU 10, whereby a resistance to an error can be improved by allowing each of the sub ECUs to perform complementary roles.

Undescribed reference numerals 51 and 52 of FIG. 1, a first individual sensor 51 and a second individual sensor 52 which output the sensing values as the bases at the time when the first sub ECU 21 and the third sub ECU 23 control the driving of the first actuator 31 and the driving of the third actuator 33, represent sensors in which the sensing values are not shared by two or more subs ECUs 21, 22 and 23.

Undescribed reference numeral 60 is a bus for exchanging data between components of the network system in accordance with the present invention, which supports a TDMA-based communication network, for example, the FlexRay protocol.

Hereinafter, according to the above-mentioned configuration, a method of controlling the network system in accordance with the present invention will be described in detail.

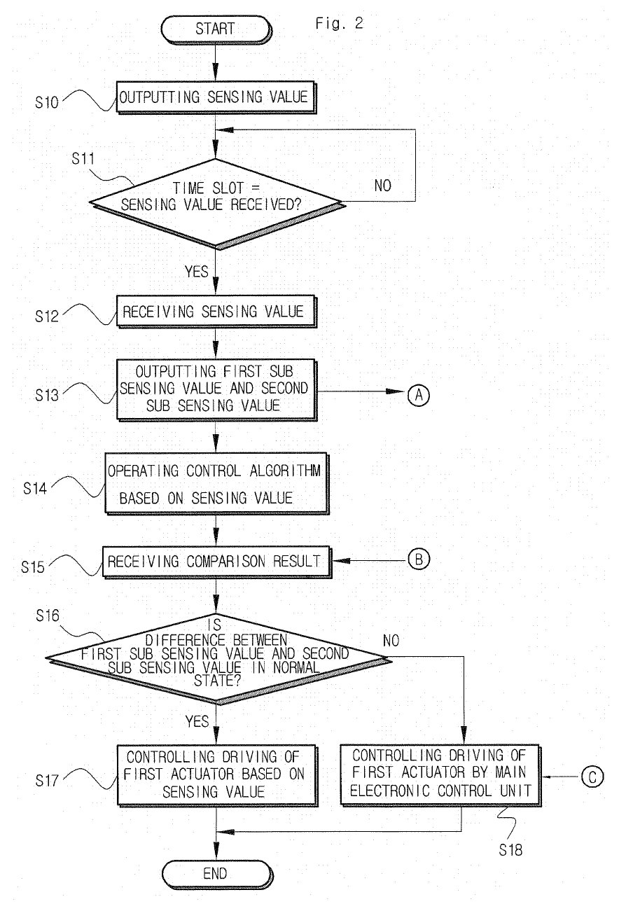

FIG. 2 is a diagram illustrating an operation process of the first sub ECU 21 (or the second sub ECU 22, hereinafter, the same as above) in the network system in accordance with the present invention.

Referring to FIG. 2, the sensing value according to the sensing result of the first shared sensor 41 is outputted from the first shared sensor 41 (S10), the first sub ECU 21 determines whether or not a current time slot matches with a time slot receiving the sensing value (S11), and the sensing value is received from the first shared sensor 41 in case that the current time slot matches with the time slot receiving the sensing value (S12).

The first sub ECU 21 generates and outputs the first sub sensing value (or the second sub sensing value, hereinafter, the same as above) on the basis of the sensing value received from the first shared sensor 41 (S13). At this time, the first sub ECU 21 operates a control algorithm based on the sensing value received from the first shared sensor 41 (S14) and the control algorithm before a final output for controlling the driving of the first actuator 31 (or the second actuator 32, hereinafter, the same as above) is performed.

Meanwhile, a comparison result is received from the main ECU 10 in correspondence with the first sensing value (S15) and the driving of the first actuator 31 is controlled by finally performing the control algorithm based on the sensing value (S17) when the comparison result is recognized as a normal state (S16).

Meanwhile, in case that the comparison result is not in the normal state, the driving of the first actuator 31 is controlled by the main ECU 10 as described above (S18).

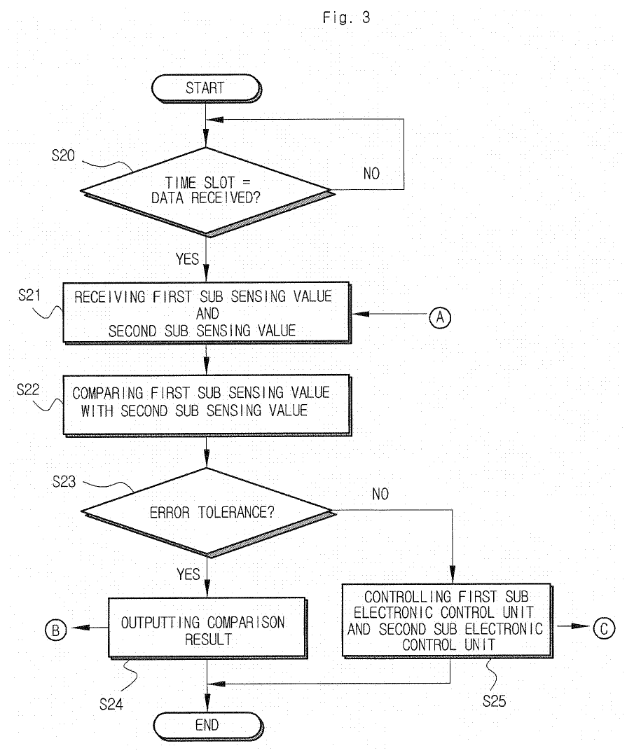

To describe the operation process of the main ECU 10 with reference to FIG. 3, the main ECU 10 receives the first sub sensing value and the second sub sensing value from the first sub ECU 21 and the second sub ECU 22 (S21) in a state that the time slot receives the data (S20). After then, the main ECU 10 calculate the difference between the first sub sensing value and the second sub sensing value by comparing the first sub sensing value with the second sub sensing value (S22).

The main ECU 10 determines whether or not the calculated difference is out of the error tolerance (S23) and transmits the corresponding comparison result to the first sub ECU 21 and the second sub ECU 22 (S24). In case that the main ECU 10 determines that the difference is out of the error tolerance, the main ECU 10 controls the first sub ECU 21 and the second sub ECU 22 in the same manner as above.

Although preferred embodiments of the present invention have been described in detail, the appended claims of the present invention is not limited to the preferred embodiment of the present invention and it will be apparent to those skilled in the art that various changes and modifications may be made without departing from the scope of the present invention as defined in the appended claims.

What is claimed is:

1. An in-vehicle network system, comprising:
a first actuator and at least one second actuator;
at least one shared sensor outputting a sensing value according to a sensing result;
a first sub ECU (Electronic Control Unit) controlling the driving of the first actuator and outputting a first sub sensing value corresponding to the sensing value received from the shared sensor;
a second sub ECU controlling the driving of the first actuator and outputting a second sub sensing value corresponding to the sensing value received from the shared sensor; and
a main ECU communicating with the first sub ECU and the second sub ECU according to a TDMA (Time Division Multiple Access)-based communication protocol, and determining that any one of the first ECU and the second ECU is abnormal in case that a difference between the first sensing value and the second sensing value respectively outputted from the first sub ECU and the second sub ECU is out of a previously set error tolerance.

2. The network system as recited in claim 1, wherein the TDMA-based communication protocol includes a FlexRay protocol.

3. The network system as recited in claim 2, wherein the main ECU transmits a middle value between the first sub sensing value and the second sub sensing value to at least any one of the first sub ECU and the second sub ECU in case that the difference between the first sub sensing value and the second sub sensing value is out of the error tolerance, and
wherein the first sub ECU and the second sub ECU controls the driving of the first actuator and the driving of the second actuator on the basis of the middle value transmitted from the main ECU.

4. The network system as recited in claim 2, wherein the main ECU controls the driving of at least any one of the first actuator and the second actuator by taking over a control right of the driving of at least any one of the first actuator and the second actuator from at least any one of the first sub ECU and the second sub ECU in case that the difference between the first sub sensing value and the second sub sensing value is out of the error tolerance.

5. The network system as recited in claim 2, wherein the main ECU requests the first sub ECU and the second sub ECU to retransmit the first sub sensing value and the second sub sensing value in case that the difference between the first sub sensing value and the second sub sensing value is out of the error tolerance, and
wherein the first sub ECU and the second sub ECU receives the sensing values from the shared sensor again to regenerate the first sub sensing value and the second sub sensing value, and reoutput the first sub sensing value and the second sub sensing value to the main ECU.

6. The network system as recited in claim 2, wherein the main ECU informs at least any one of the first sub ECU and the second sub ECU of information on a normal state in case that the difference between the first sub sensing value and the second sub sensing value is within the error tolerance, and
wherein the first sub ECU and the second sub ECU controls the drivings of the first actuator and the second actuator on the basis of the sensing value of the shared sensor in case that the information on the normal state is received from the main ECU.

7. The network system as recited in claim 1, wherein the sensing value outputted from the shared sensor includes an analog signal pattern, and the first sub sensing value and the second sub sensing value include a digital signal pattern,
wherein the first sub ECU includes a first A/D converter for converting the sensing value of the analog signal pattern into the first sub sensing value of the digital signal pattern, and
wherein the second sub ECU includes a second A/D converter for converting the sensing value of the analog signal pattern into the second sub sensing value of the digital signal pattern.

8. The network system as recited in claim 2, wherein the sensing value outputted from the shared sensor includes an analog signal pattern, and the first sub sensing value and the second sub sensing value include a digital signal pattern,
wherein the first sub ECU includes a first A/D converter for converting the sensing value of the analog signal pattern into the first sub sensing value of the digital signal pattern, and
wherein the second sub ECU includes a second A/D converter for converting the sensing value of the analog signal pattern into the second sub sensing value of the digital signal pattern.

9. The network system as recited in claim 3, wherein the sensing value outputted from the shared sensor includes an analog signal pattern, and the first sub sensing value and the second sub sensing value include a digital signal pattern,
wherein the first sub ECU includes a first A/D converter for converting the sensing value of the analog signal pattern into the first sub sensing value of the digital signal pattern, and
wherein the second sub ECU includes a second A/D converter for converting the sensing value of the analog signal pattern into the second sub sensing value of the digital signal pattern.

10. The network system as recited in claim 4, wherein the sensing value outputted from the shared sensor includes an analog signal pattern, and the first sub sensing value and the second sub sensing value include a digital signal pattern,
wherein the first sub ECU includes a first A/D converter for converting the sensing value of the analog signal pattern into the first sub sensing value of the digital signal pattern, and
wherein the second sub ECU includes a second A/D converter for converting the sensing value of the analog signal pattern into the second sub sensing value of the digital signal pattern.

11. The network system as recited in claim 5, wherein the sensing value outputted from the shared sensor includes an analog signal pattern, and the first sub sensing value and the second sub sensing value include a digital signal pattern,
wherein the first sub ECU includes a first A/D converter for converting the sensing value of the analog signal pattern into the first sub sensing value of the digital signal pattern, and
wherein the second sub ECU includes a second A/D converter for converting the sensing value of the analog signal pattern into the second sub sensing value of the digital signal pattern.

12. The network system as recited in claim 6, wherein the sensing value outputted from the shared sensor includes an analog signal pattern, and the first sub sensing value and the second sub sensing value include a digital signal pattern,
wherein the first sub ECU includes a first A/D converter for converting the sensing value of the analog signal pattern into the first sub sensing value of the digital signal pattern, and
wherein the second sub ECU includes a second A/D converter for converting the sensing value of the analog signal pattern into the second sub sensing value of the digital signal pattern.

13. A method of controlling an in-vehicle network system comprising the steps of:
outputting a sensing value according to a sensing result from a shared sensor;
outputting a first sub sensing value corresponding to the sensing value by a first sub ECU(Electronic Control Unit) controlling the driving of a first actuator;
outputting a second sub sensing value corresponding to the sensing value by a second sub ECU controlling the driving of a second actuator;
inputting the first sensing value and the second sensing value to a main ECU communicating with the first sub ECU and the second sub ECU according to a TDMA (Time Division Multiple Access)-based communication protocol; and
determining that any one of the first sub ECU and the second sub ECU is abnormal by the main ECU in case that a difference between the first sub sensing value and the second sub sensing value is out of a previously set error tolerance.

14. The method of controlling the network system as recited in claim 13, wherein a TDMA-based communication protocol includes a FlexRay protocol.

15. The method of controlling the network system as recited in claim 14, further comprising the steps of:
transmitting a middle value between the first sub sensing value and the second sub sensing value to at least any one of the first sub ECU and the second sub ECU by the main ECU in case that the difference between the first sub sensing value and the second sub sensing value is out of the error tolerance; and
controlling the driving the first actuator and the driving of the second actuator on the basis of the middle value transmitted from the main ECU by the first sub ECU and the second sub ECU.

16. The method of controlling the network system as recited in claim 14, further comprising the step of: controlling the driving of at least any one of the first actuator and the second actuator by the main ECU by taking over a control right of the driving of at least any one of the first actuator and the second actuator from at least any one of the first sub ECU and the second sub ECU to the main ECU in case that the difference between the first sub sensing value and the second sub sensing value is out of the error tolerance.

17. The method of controlling the network system as recited in claim 14, further comprising the steps of:
requesting the first sub ECU and the second sub ECU to retransmit the first sub sensing value and the second sub sensing value by the main ECU in case that the difference between the first sensing value and the second sensing value is out of the error tolerance;
respectively receiving the sensing values from the shared sensor again by the first sub ECU and the second sub ECU to regenerate the first sub sensing value and the second sub sensing value; and
reoutputting the regenerated first sub sensing value and the regenerated second sub sensing value to the main ECU by the first sub ECU and the second sub ECU.

18. The method of controlling the network system as recited in claim 14, further comprising the steps of:
informing at least any one of the first sub ECU and the second sub ECU of information on a normal state by the main ECU in case that the difference between the first sub sensing value and the second sub sensing value is determined within the error tolerance by the main ECU; and
controlling the driving of the first actuator and the second actuator on the basis of the sensing value of the shared sensor by the first sub ECU and the second sub ECU in case that the information on the normal state is received from the main ECU.

19. The network system as recited in claim 13, wherein the sensing value outputted from the shared sensor includes an analog signal pattern, and the first sub sensing value and the second sub sensing value include a digital signal pattern,
wherein the step of outputting the first sub sensing value includes a step of converting the sensing value of the analog signal pattern into the first sub sensing value of the digital signal pattern, and
wherein the step of outputting the second sensing value includes a step of converting the sensing value of the analog signal pattern into the second sub sensing value of the digital signal pattern.

20. The network system as recited in claim 14, wherein the sensing value outputted from the shared sensor includes an analog signal pattern, and the first sub sensing value and the second sub sensing value include a digital signal pattern,
wherein the step of outputting the first sub sensing value includes a step of converting the sensing value of the analog signal pattern into the first sub sensing value of the digital signal pattern, and
wherein the step of outputting the second sensing value includes a step of converting the sensing value of the analog signal pattern into the second sub sensing value of the digital signal pattern.

21. The network system as recited in claim 15, wherein the sensing value outputted from the shared sensor includes an analog signal pattern, and the first sub sensing value and the second sub sensing value include a digital signal pattern,
wherein the step of outputting the first sub sensing value includes a step of converting the sensing value of the analog signal pattern into the first sub sensing value of the digital signal pattern, and
wherein the step of outputting the second sensing value includes a step of converting the sensing value of the analog signal pattern into the second sub sensing value of the digital signal pattern.

22. The network system as recited in claim 16, wherein the sensing value outputted from the shared sensor includes an analog signal pattern, and the first sub sensing value and the second sub sensing value include a digital signal pattern,
wherein the step of outputting the first sub sensing value includes a step of converting the sensing value of the analog signal pattern into the first sub sensing value of the digital signal pattern, and
wherein the step of outputting the second sensing value includes a step of converting the sensing value of the analog signal pattern into the second sub sensing value of the digital signal pattern.

23. The network system as recited in claim 17, wherein the sensing value outputted from the shared sensor includes an analog signal pattern, and the first sub sensing value and the second sub sensing value include a digital signal pattern,
wherein the step of outputting the first sub sensing value includes a step of converting the sensing value of the analog signal pattern into the first sub sensing value of the digital signal pattern, and
wherein the step of outputting the second sensing value includes a step of converting the sensing value of the analog signal pattern into the second sub sensing value of the digital signal pattern.

24. The network system as recited in claim 18, wherein the sensing value outputted from the shared sensor includes an analog signal pattern, and the first sub sensing value and the second sub sensing value include a digital signal pattern,
wherein the step of outputting the first sub sensing value includes a step of converting the sensing value of the analog signal pattern into the first sub sensing value of the digital signal pattern, and
wherein the step of outputting the second sensing value includes a step of converting the sensing value of the analog signal pattern into the second sub sensing value of the digital signal pattern.
